(19) United States
(12) Patent Application Publication
(10) Pub. No.: US 2016/0323371 A1
(43) Pub. Date: Nov. 3, 2016

(54) METHODS AND APPARATUS FOR LOAD BALANCING IN A NETWORK

(71) Applicant: TELEFONAKTIEBOLAGET LM ERICSSON (PUBL), Stockholm (SE)

(72) Inventors: Xuehong DENG, Guangzhou (CN); Yang JIANG, Guangzhou (CN); Kemin QIU, Guangzhou (CN); Bin ZENG, Guangzhou (CN)

(73) Assignee: Telefonaktiebolaget LM Ericsson (publ), Stockholm (SE)

(21) Appl. No.: 15/107,742

(22) PCT Filed: Dec. 24, 2013
(86) PCT No.: PCT/CN2013/090305

§ 371 Date: Jun. 23, 2016

(51) Int. Cl. H04L 29/08; H04L 12/841; H04L 12/803

(52) U.S. Cl. CPC H04L 67/1008; H04L 67/1023; H04L 67/1017; H04L 67/1014; H04L 47/125; H04L 67/1031; H04L 47/28

(57) ABSTRACT

The invention provides a load balancer (300) and a system (200) comprising a load balancer for use in a computer network and for distributing network traffic between one or more of a plurality of traffic servers (206a-c). The load balancer comprises an external receiver (305) configured to receive data packets from a client side (216) and/or a server side (218). The load balancer comprises a traffic scheduler (314) configured to determine a traffic server to which a received data packet is to be transmitted. The load balancer comprises an internal transmitter (302) configured to transmit the data packet to the determined traffic server. If the data packet is received from the client side, the traffic scheduler is configured to determine the traffic server based on a source network address for the data packet. If the data packet is received from the server side, the traffic scheduler is configured to determine the traffic server based a destination network address for the data packet.

### TECHNICAL FIELD

The invention relates to methods and apparatus for load balancing in a network. More specifically, the invention relates to, but is not limited to, methods and apparatus for load balancing when handling requests from clients to servers and the subsequent responses.

### BACKGROUND

Load balancers are employed in computer networks to distribute tasks required for operation of the network between a plurality of computers, in order to balance the load across a number of network nodes.

Typically, a load balancing system may be a cluster system that comprises a plurality of traffic servers configured to handle network data traffic. In exemplary load balancing systems, the cluster system requires a load balancer as a single ingress and/or egress point for all the request and response traffic between a client or user equipment (UE) and a server.

A schematic representation of a system 100 is shown in FIG. 1. The system 100 comprises a first active load balancer 104 in electrical communication with a plurality of traffic servers 106a-c, which are in communication with a second active load balancer 108. There may be any number of traffic servers 106a-c, as denoted by the nth traffic server 106c. Exemplary systems may also comprise a UE 102 and/or an origin server 110, although these features are not essential to the system 100. The first active load balancer 104 is in electrical communication with the UE 102 and the second active load balancer 108 is also in electrical communication with the origin server 110. In addition to the first and second active load balancers 104, 108, the system 100 also comprises first and second standby load balancers 112, 114, which may be used if one of the active load balancers 104, 108 becomes inoperable. The first active load balancer 104 is in electrical communication with the first standby load balancer 112 and the second active load balancer 108 is in electrical communication with the second standby load balancer 114. Further, the first and second active load balancers 104, 108 and the first and second standby load balancers 112, 114 may be different logical load balancers, although they may be hosted on one physical load balancer, as shown by the hashed lines connecting the load balancers in FIG. 1.

A typical communication flow is shown by the numbered arrows 1-8 in FIG. 1 and briefly explained below.
1. The UE 102 transmits a request for data from the origin server 110, the request is received by the first active load balancer 104. The request is transmitted as a plurality of data packets and, based on a maximum transmission unit (MTU) of a network protocol, may be fragmented into a plurality of data packets, as set out in the network protocol, which may be, for example, the Internet Protocol
2. The first active load balancer 104 performs defragmentation on the received data packets, determines a traffic server 106a-c that will handle the request, fragments the data packets and transmits the fragmented data packets to the determined traffic server 106b
3. The traffic server 106b processes the request and transmits the fragmented data packets to the second active load balancer 108
4. The second active load balancer 108 defragments the request and then fragments it once again before transmission across the network to the origin server 110
5. The origin server 110 responds to the request and transmits the response in fragmented data packets to the second active load balancer 108.

6. The second active load balancer 108 defragments the fragmented data packets, fragments them once again and transmits them to traffic server 106b. The second active load balancer 108 knows to transmit the response to traffic server 2, as session data from steps 3 and 4 has been maintained by the second active load balancer 108
7. The traffic server 106b processes the response and transmits the fragmented data packets to the first active load balancer 104
8. The first active load balance 104 defragments and then fragments the data packets of the response and transmits them to the UE 102

In order to undertake the steps mentioned above, the first and second load balancers 104, 108 must maintain session data to ensure that one session (e.g. one request and response) can be handled by one traffic server 106a-c. When a response from the origin server arrives at a load balancer 108, the load balancer 108 searches for the correct traffic server 106a-c that is handling the current session and that handled transmission of the request. The session is set up during a request from the UE 102 to the origin server 110. Further, the first and second load balancers 104, 108 must maintain the traffic connection status for the session. The session data and connection data must also be synchronized in the first and second standby load balancers 112, 114 so that service can be maintained if one of the first and second active load balancers 104, 108 goes down.

In addition, all the fragmented data packets received are defragmented and then fragmented again by the active load balancers 104, 108 in order to forward the complete traffic to one traffic server 106a-c, and to fragment the data into multiple packets when sending out the data.

### SUMMARY

It is an object of the invention to alleviate some of the disadvantages with current methods and apparatus for load balancing in computer networks.

According to the invention in a first aspect, there is provided a load balancer (300) for use in a computer network and for distributing network traffic between one or more of a plurality of traffic servers (206a-c). The load balancer comprises an external receiver (305) configured to receive data packets from a client side (216) and/or a server side (218). The load balancer comprises a traffic scheduler (314) configured to determine a traffic server to which a received data packet is to be transmitted. The load balancer comprises an internal transmitter (302) configured to transmit the data packet to the determined traffic server. If the data packet is received from the client side, the traffic scheduler is configured to determine the traffic server based on a source network address for the data packet. If the data packet is received from the server side, the traffic scheduler is configured to determine the traffic server based a destination network address for the data packet.

By basing the determination of the traffic server on the source network address or the destination network address, the same traffic server is determined for all data packets from/to a particular address without the need for defragmentation.

Optionally, the traffic scheduler (314) is configured to determine the traffic server (206a-c) using a hash of the source or destination network address.

Optionally, the load balancer further comprises a traffic context (316) configured to determine the traffic domain and the direction of the data packet.

Optionally, the external receiver (304) is configured to receive requests comprising received data packets from a user equipment (202) on the client side (216) and/or to receive responses comprising received data packets, from an origin server (210) on the server side (218), wherein, for a given user equipment, the same traffic server (206a-c) is determined for the requests and responses.

Optionally, the load balancer further comprises a fragmentation filter (318) configured to determine whether the received data packets comprise fragmented data requiring defragmentation and fragmentation before transmission to a traffic server, wherein, if the fragmentation filter determines that the data packets require defragmentation and fragmentation, a defragmenter (320) is configured to defragment the data packets and a fragmenter (322) is configured to fragment the defragmented data packets.

Optionally, the fragmentation filter (318) is configured to determine whether the received data packets require defragmentation and fragmentation based on whether the received data packets must be defragmented to determine header information relating to a plurality of fragmented data packets.

Optionally, the fragmentation filter (318) is configured to determine whether the received data packets require defragmentation and fragmentation based on a source network address for the data packets received from the client side.

Optionally, the fragmentation filter (318) is configured to determine whether the received data packets require defragmentation and fragmentation based on a destination address for the data packets received from the server side.

Optionally, the fragmentation filter (318) is configured to determine that the received data packets require defragmentation and fragmentation if the data packets require round-robin scheduling.

Optionally, the traffic scheduler (314) is further configured to associate each of the plurality of traffic servers with at least one identifier, and to store the associations in a memory.

Optionally, if one or more of the plurality of traffic servers is unavailable, the traffic scheduler is configured to distribute data packets to one or more remaining traffic servers based on the stored associations between the traffic servers and the at least one identifier without affecting the identifier associated with each traffic server.

Optionally, the traffic scheduler is configured to store the associations between the traffic servers and the at least one identifier in the memory using a slice table.

Optionally, the traffic scheduler is configured to distribute data packets evenly between remaining available traffic servers.

According to the invention in a second aspect, there is provided a network node comprising a load balancer as discussed above.

According to the invention in a third aspect, there is provided a method for distributing network traffic between one or more of a plurality of traffic servers (206a-c). The method comprises receiving (400), by an external receiver (305), a data packet from a client side (216) and/or a server side (218). The method comprises determining (412, 414), by a traffic scheduler (314), a traffic server to which the received data packet is to be transmitted. The method comprises transmitting (418), by an internal transmitter (302), the data packet to the determined traffic server. If the data packet is received from the client side, the traffic server is determined (412) based on a source network address for the data packet. If the data packet is received from the server side, the traffic server is determined (414) based on a destination network address for the data packet.

Optionally, determining (412, 414) the traffic server (206a-c) using a hash of the source or destination network address.

Optionally, the method further comprises determining, by a traffic context (316), the traffic domain and the direction of the data packet.

Optionally, receiving a data packet (400) comprises receiving requests from a user equipment (202) on the client side (216) and/or receiving responses from an origin server (210) on the server side (218), wherein, for a given user equipment, the same traffic server (206a-c) is determined (412, 414) for the requests and responses.

Optionally, the method further comprises determining, by a fragmentation filter (318), whether the received data packets comprise fragmented data requiring defragmentation and fragmentation before transmission to a traffic server, wherein, if the fragmentation filter determines that the data packets require defragmentation and fragmentation, the method further comprises defragmenting, by a defragmenter (320), the data packets and fragmenting, by a fragmenter (322), the defragmented data packets.

Optionally, determining whether the received data packets require defragmentation and fragmentation is based on whether the received data packets must be defragmented to determine header information relating to a plurality of fragmented data packets.

Optionally, determining whether the received data packets require defragmentation and fragmentation is based on a source network address for the data packets received from the client side.

Optionally, determining whether the received data packets require defragmentation and fragmentation is based on a destination address for the data packets received from the server side.

Optionally, determining that the received data packets require defragmentation and fragmentation is based on whether the data packets require round-robin scheduling.

Optionally, the method further comprises associating, by the traffic scheduler (314), each of the plurality of traffic servers with at least one identifier, and to storing, by the traffic scheduler, the associations in a memory.

Optionally, if one or more of the plurality of traffic servers is unavailable, the traffic scheduler (314) distributes data packets to one or more remaining traffic servers based on the stored associations between the traffic servers and the at least one identifier without affecting the identifier associated with each traffic server.

Optionally, the traffic scheduler (314) stores the associations between the traffic servers and the at least one identifier in the memory using a slice table.

Optionally, the traffic scheduler distributes data packets evenly between remaining available traffic servers.

According to the invention in a fourth aspect, there is provided a non-transitory computer readable medium (312) comprising computer readable code configured, when read by a computer, to carry out the method discussed above.

According to the invention in a fifth aspect, there is provided a computer program (310) comprising computer readable code configured, when read by a computer, to carry out the method discussed above.

According to the invention in a sixth aspect, there is provided a system (200) for use in a computer network and for distributing network traffic between one or more of a plurality of traffic servers (206a-c). The system comprises first (204) and second (208) load balancers and a plurality of traffic servers. The first load balancer comprises a first external receiver (305) configured to receive a first data packet from a client side node (102). The first load balancer comprises a first traffic scheduler (314) configured to determine a first traffic server (206b) from the plurality of traffic servers based on a source network address for the first data packet. The first load balancer comprises a first internal transmitter (302) configured to transmit the first data packet to a second internal receiver 304 of the second load balancer via the determined first traffic server. A second external transmitter (303) of the second load balancer is configured to transmit the first data packet to a server side node (210). The second load balancer comprises a second external receiver (305) configured to receive a second data packet from the server side node. The second load balancer comprises a second traffic scheduler (314) configured to determine a second traffic server (206b) from the plurality of traffic servers based on a destination network address for the second data packet. The second load balancer comprises a second internal transmitter (302) configured to transmit the second data packet to a first internal receiver (304) of the first load balancer via the determined second traffic server. A first external transmitter (303) of the first load balancer being configured to transmit the second data packet to the client side node. The first determined traffic server is the same as the second determined traffic server.

According to the invention in a seventh aspect, there is provided a method for operating a system (200) for use in a computer network and for distributing network traffic between one or more of a plurality of traffic servers (206a-c). The method comprises, at a first active load balancer (204): receiving (502), by a first external receiver (305) a first data packet from a client side node (102); determining (506), by a first traffic scheduler (314), a first traffic server (206b) from the plurality of traffic servers based on a source network address for the first data packet; and transmitting (508), by a first internal transmitter (302), the first data packet to a second load balancer (208) via the determined first traffic server. The method comprises, at a second load balancer (208): receiving, at a second internal receiver (304), the first data packet; transmitting (514), by a second external transmitter (302), the first data packet to a server side node (210); receiving (518), by a second external receiver (305), a second data packet from the server side node; determining (522), by a second traffic scheduler (314), a second traffic server (206b) from the plurality of traffic servers based on a destination network address for the second data packet; transmitting (524), by a second internal transmitter (302), the second data packet to the first or a further load balancer via the determined second traffic server. The method further comprises, at the first or further load balancer: transmitting (530), by a first external transmitter (303), the second data packet to the client side node. The first determined traffic server is the same as the second determined traffic server.

According to the invention in an eighth aspect, there is provided a load balancer (800) for use in a computer network and for distributing network traffic between one or more of a plurality of traffic servers (206a-c). The load balancer comprises a receiver (804) configured to receive a plurality of data packets from a client side (216) and/or a server side (218). The load balancer comprises a traffic scheduler (814) configured to determine one or more traffic servers to which the data packets are to be transmitted. The load balancer comprises a transmitter (802) configured to transmit the data packets to the one or more determined traffic servers. The traffic scheduler is further configured to associate each of the plurality of traffic servers with a unique identifier, and to store the associations in a memory. If one or more of the plurality of traffic servers is unavailable, the traffic scheduler is configured to distribute data packets to one or more remaining traffic servers based on the stored associations between the traffic servers and the at least one identifier without affecting the identifier associated with each traffic server.

Optionally, the traffic scheduler (814) is configured to store the associations between the traffic servers and the at least one identifier in the memory using a slice table.

Optionally, the traffic scheduler (814) is configured, if one or more of the plurality of traffic servers is unavailable, to determine one or more second traffic servers to which the data packets are to be transmitted based on the slice table.

According to the invention in an ninth aspect, there is provided a method for distributing network traffic between one or more of a plurality of traffic servers (206a-c). The method comprises associating (1000), by a traffic scheduler (814), each of the plurality of traffic servers with a unique identifier. The method comprises storing (1002) the associations in a memory (806). The method comprises receiving (1004), by a receiver (804), a plurality of data packets from a client side (216) and/or a server side (218). The method comprises determining (1006), by a traffic scheduler (814), one or more traffic servers to which the data packets are to be transmitted. If one or more of the plurality of traffic servers is unavailable, distributing (1008), by the traffic scheduler, the data packets to one or more remaining traffic servers based on the stored associations between the traffic servers and the at least one identifier without affecting the identifier associated with each traffic server.

According to the invention in an tenth aspect, there is provided a non-transitory computer readable medium (812) comprising computer readable code configured, when read by a computer, to carry out the method discussed above.

According to the invention in an eleventh aspect, there is provided a computer program (810) comprising computer readable code configured, when read by a computer, to carry out the method discussed above.

### BRIEF DESCRIPTION OF DRAWINGS

Exemplary embodiments of the invention are disclosed herein with reference to the accompanying drawings, in which:

FIG. 1 is a schematic representation of a system according to the prior art;

FIG. 2 is a schematic representation of a system;

FIG. 3 is a schematic representation of a load balancer;

FIG. 4 is a flow diagram of a method for distributing network traffic between one or more of a plurality of traffic servers;

FIG. 5 is a flow diagram of a method for operating a system;

FIG. 6 is a schematic representation of a load balancer;

FIG. 7 is a flow diagram of a method for operating a load balancer;

FIG. 8 is a schematic representation of a load balancer;

FIGS. 9a and 9b show exemplary slice tables; and

FIG. 10 is a flow diagram of a method for operating a load balancer.

### DETAILED DESCRIPTION

In order to achieve load balancing and the reverse routing functionality, current systems are very complex. Specifically, the inventors have appreciated that known systems have disadvantages in the following areas:
Computational burden
Known load balancers are configured to analyze, maintain and store the status of a current session and connection, as it relates to a particular request (from a UE) and response (from an origin server). Further, load balancers are required to defragment and fragment the data packets for all types of network traffic. This results in a high computational burden on the load balancer.
Memory Management
Large amounts of session data and connection data are required to be stored by load balancers to ensure that the same traffic server is used for reverse routing. This results in memory management complexity and high memory consumption both for the load balancing and reverse routing.
Synchronization
All the session and connection data stored by the active load balancers has to be synchronized with the standby load balancers. This is an additional computational burden and introduces further complexity to the system.

The inventors have appreciated that the above mentioned disadvantages can lead to low traffic throughput, low stability of the load balancer, large latency in data request processing and high maintenance costs.

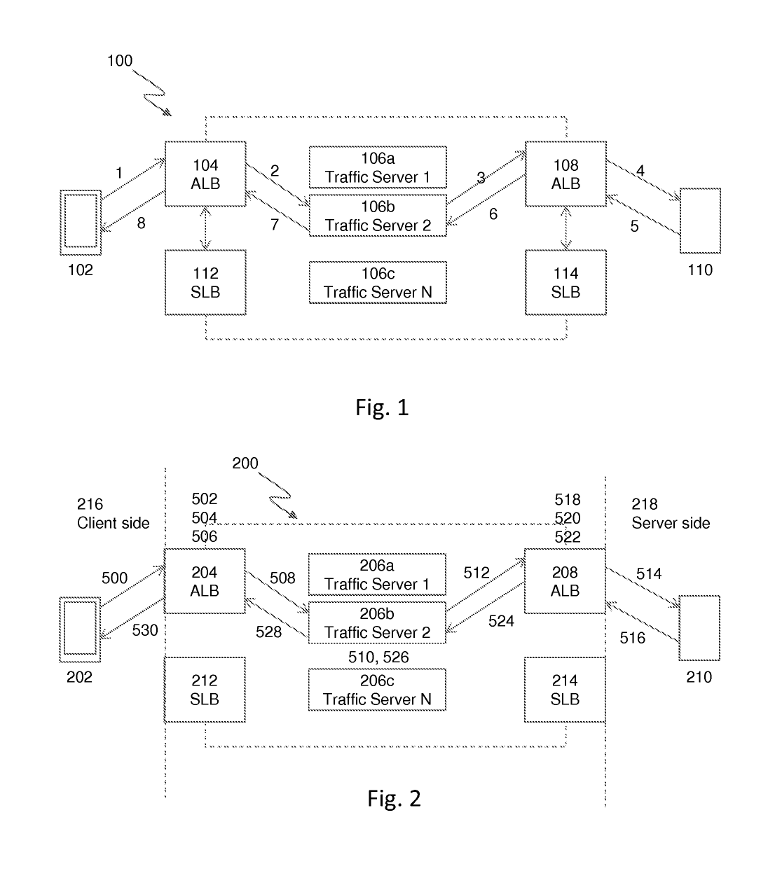

Moreover, the cluster system described above with reference to FIG. 1 is evolving to a cloud based system, in which there will be multiple load balancer instances within the cloud. The problems and disadvantages mentioned above provide a barrier to the implementation of cloud based load balancing and reverse routing.

Generally, disclosed herein are apparatus and methods for load balancing in a computer network. Exemplary methods and apparatus disclosed provide reverse routing based on source network addresses and destination network addresses for data packets. Exemplary methods and apparatus disclosed may also comprise a fragmentation filter configured to determine whether data packets require defragmentation and further fragmentation. Exemplary methods and apparatus disclosed may also comprise a traffic scheduler configured to associate a plurality of traffic servers each with a unique identifier. In addition, disclosed herein are calculation based methods and apparatus for both load balancing and reverse routing. These are instead of existing complex solutions based on session management and data synchronization. Exemplary calculation based methods and apparatus may apply defragmentation and fragmentation only when necessary and route the traffic to the correct traffic server during reverse routing using traffic context, which determines the traffic server based on the source or destination address for a packet.

FIG. 2 shows a schematic representation of a system 200. The system 200 comprises first and second active load balancers 204, 208, first and second standby load balancers 212, 214 and a plurality of traffic servers 206a-c. FIG. 2 comprises similar features to those seen in FIG. 1, which is described above. As such, those features are not described in detail again here.

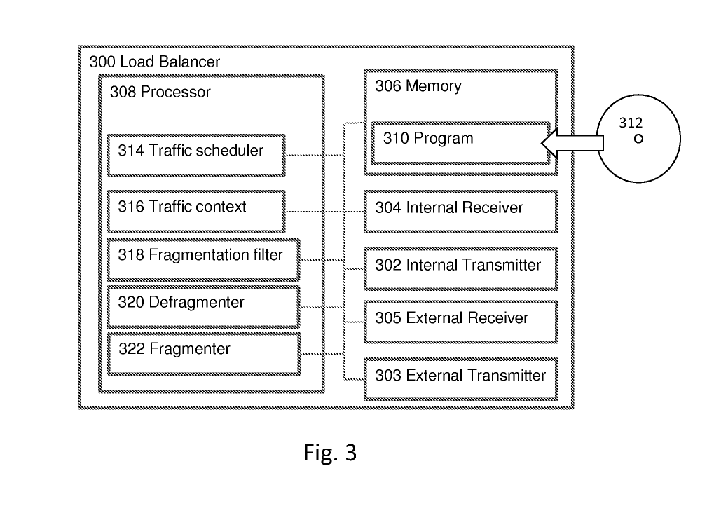

FIG. 3 shows a schematic representation of a load balancer 300. The load balancer 300 comprises an internal transmitter 302 and an internal receiver 304. The internal transmitter 302 and internal receiver 304 are in electrical communication with the traffic servers 206a-c and are configured to transmit and receive data accordingly. The load balancer 300 also comprises an external transmitter 303 and an external receiver 305 in electrical communication with other nodes, UEs, servers or origin servers and/or functions in a computer network and configured to transmit and receive data accordingly. It is noted that the load balancer 300 may comprise a single transmitter configured to undertake the function of both the internal and external transmitters 302, 303, and a single receiver configured to undertake the function of both the internal and external receivers 304, 305.

The load balancer 300 further comprises a memory 306 and a processor 308. The memory 306 may comprise a non-volatile memory and/or a volatile memory. The memory 306 may have a computer program 310 stored therein. The computer program 310 may be configured to undertake the methods disclosed herein. The computer program 310 may be loaded in the memory 306 from a non-transitory computer readable medium 312, on which the computer program is stored. The processor 308 is configured to undertake the functions of a traffic scheduler 314, a traffic context 316, a fragmentation filter 318, a defragmenter 320 and a fragmenter 322.

Each of the internal and external transmitters 302, 303, internal and external receivers 304, 305, memory 306, processor 308, traffic scheduler 314, traffic context 316, fragmentation filter 318, defragmenter 320 and fragmenter 322 is in electrical communication with the other features 302, 303 304, 305 306, 308, 310, 314, 316, 318, 320, 322 of the load balancer 300. The load balancer 300 can be implemented as a combination of computer hardware and software. In particular, the traffic scheduler 314, traffic context 316, fragmentation filter 318, defragmenter 320 and fragmenter 322 may be implemented as software configured to run on the processor 308. The memory 306 stores the various programs/executable files that are implemented by a processor 308, and also provide a storage unit for any required data. The programs/executable files stored in the memory 306, and implemented by the processor 308, can include the traffic scheduler 314, traffic context 316, fragmentation filter 318, defragmenter 320 and fragmenter 322, but are not limited to such.

Returning to FIG. 2, each of the load balancers 204, 208, 212, 214 may be a load balancer 300, as shown in FIG. 3.

The load balancer 300 is for distributing network traffic between a plurality of traffic servers 206a-c. The external receiver 305 is configured to receive data packets from a client side 216 of the system 200, or a server side 218 of the system 200. In the exemplary system 200 shown in FIG. 2, the first active load balancer 204 is configured to receive data packets from the client side 216 and the second active load balancer 208 is configured to receive data packets from the server side 218. The standby load balancers 212, 214 are configured in the same manner as their respective active load balancers 204, 208.

The traffic scheduler 314 is configured to determine a traffic server 206a-c to which data packets received at the load balancer 300 should be transmitted based at least in part on a network address for the data packets. The network address may be a source address if the data packets have been received from the client side 216, and may be a destination address if the data packets have been received from the server side 218.

In exemplary load balancers 300, data packets may be received using the Internet protocol (IP), in which case, an IP source or destination address for a data packet may be used to determine the traffic server 206a-c to be used. Further, the traffic scheduler may determine the traffic server 206a-c based on a hash of the source or destination network address for a given data packet, as appropriate.

The internal transmitter 302 is configured to transmit the data packet to the determined traffic server 206a-c.

The traffic context may be configured to determine the traffic domain and the direction of a data packet received by the internal receiver 304. That is, the traffic context 316 is able to determine whether the data packet has been received from the client side 216 or the server side 218 and/or whether the data packet is on its way into the system 200, or on its way out of the system 200. The traffic domain may also identify the port number of a data packet.

When determining the traffic server 206a-c, the use of the source network address of data packets received from the client side 216 and the destination address for data packets received from the server side 218 allows data packets to be transmitted to the same traffic server during reverse routing, without the need to maintain session and connection data. Because the source network address of data packets from the client side 216 is the same as the destination network address for the packets received from the server side 218 during reverse routing, the traffic server determined in forward and reverse routing is the same.

The fragmentation filter 318 is configured to determine whether received data packets require defragmentation and subsequent fragmentation before being transmitted to a determined traffic server 206a-c.

In exemplary load balancers 300, the fragmentation filter 318 may be configured to determine that only fragmented data packets undergoing round-robin scheduling will require defragmentation and subsequent fragmentation. All other data packets may be determined not to require defragmentation and subsequent fragmentation and may be transmitted directly to the determined traffic server 206a-c.

In exemplary load balancers 300, the fragmentation filter 318 may be configured to determine that fragmented data packets arriving at a particular port and/or having a particular destination address require defragmentation and subsequent fragmentation. That is, in exemplary load balancers 300, the fragmentation filter may be configured to determine whether defragmentation is required based on a port number in an IP header for a data packet. Other data packets may be determined not to require defragmentation and subsequent fragmentation and may be transmitted directly to the determined traffic server 206a-c.

In exemplary load balancers 300, the fragmentation filter 318 may be configured to determine that fragmented data packets that must be defragmented to reveal header information will require defragmentation and subsequent fragmentation. For example, IP fragmented packets for which the Layer 3 header information is required may be determined to required defragmentation and fragmentation. Other data packets may be determined not to require defragmentation and subsequent fragmentation and may be transmitted directly to the determined traffic server 206a-c.

In exemplary load balancers 300, the fragmentation filter 318 may be configured to determine that fragmented data packets that have a fixed source network address and/or a network address in a specific range of network addresses will require defragmentation and subsequent fragmentation. Other data packets may be determined not to require defragmentation and subsequent fragmentation and may be transmitted directly to the determined traffic server 206a-c.

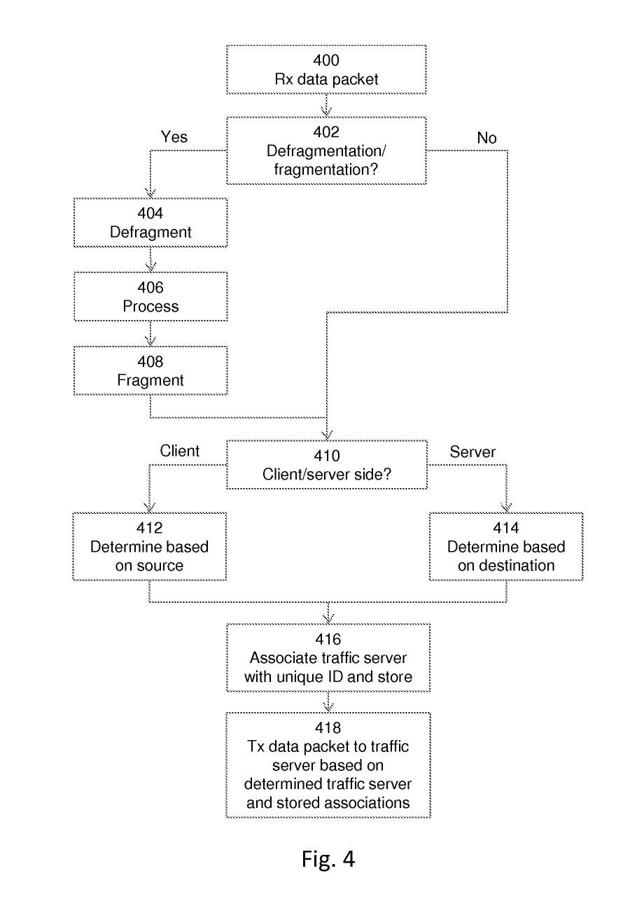

Referring to FIG. 4, an exemplary method is described below for distributing network traffic between one or more of a plurality of traffic servers 206a-c.

A data packet is received 400 by the external receiver 305 of the load balancer 300. The traffic context 316 determines 402 whether the request has been received from the client side 216 or the server side 218 and the direction of the request.

The fragmentation filter 318 determines 402 whether the received data packet requires defragmentation and subsequent fragmentation. If defragmentation/fragmentation is required, the defragmenter 320 defragments 404 received data packets. The traffic scheduler 314 then processes 406 the defragmented data packets before the fragmenter 322 fragments 408 the data packets once again for transmission to a traffic server 206a-c.

The traffic context 316 determines 410 whether the received data packets are received from the client side 216 or the server side 218.

The traffic scheduler 314 determines 412, 414 one or more of the traffic servers 206a-c to which the data packet should be transmitted. If the data packets are received from the client side 216, the traffic server 206a-c is determined 412 based on a hash of the source address for the request. If data packets are received from the server side 218, the traffic server 206a-c is determined 414 based on the destination network address for the data packet.

The traffic scheduler 314 may also be configured to associate 416 one or more traffic servers 206a-c with a unique identifier (ID). This may be done as part of a setup procedure. The associations may be stored in the memory 306 in the form of a slice table, which is a data structure wherein every slice (tuple or element) in the table could be regarded as a virtual traffic server, while a real traffic server may cover several slices. The traffic scheduler 314 may use the slice table to do the hash and then uses a relationship between a slice ID and the traffic server ID to distribute packets to the real traffic server.

The internal transmitter 302 transmits 418 the data packet to the determined traffic server 206a-c based on the stored associations. In particular, if the determined traffic server 206b is down, the traffic scheduler may distribute the data packet to another of the traffic servers 206a, 206c based on the slice table.

A traffic server may be configured to run any application. For example, a traffic server can run a transmission control protocol (TCP) optimization application, video optimization application, content optimization application, etc. A traffic server is a kind of application server that may give some support, such as recoding the packets if the packets are sent with a coding format not available at the client (it may be for example a mobile phone). Another example is a traffic server configured as a filter, which may filter out web requests that are not allowed for a particular client.

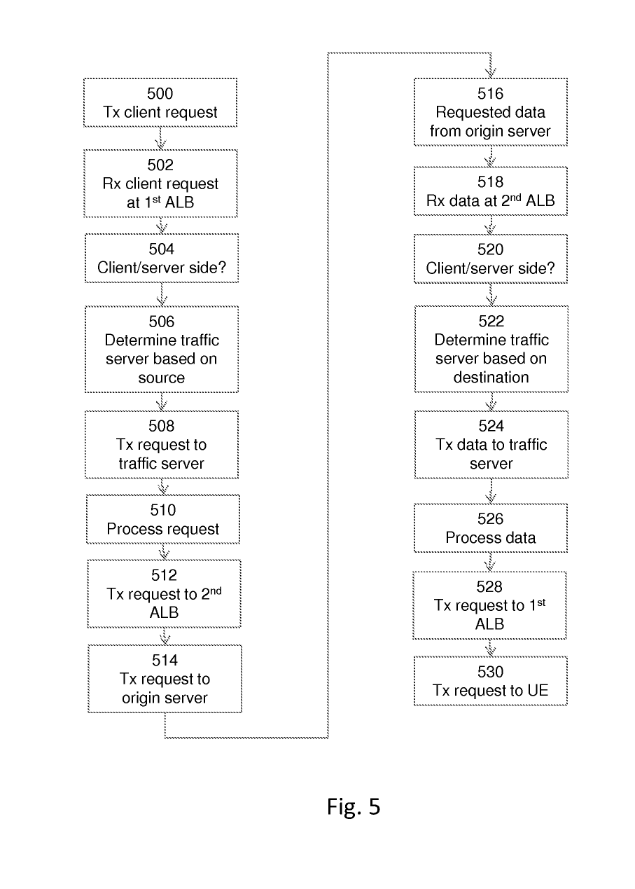

Referring to FIGS. 2 and 5, a system 200 and method for implementing a system are described. The steps of the flow diagram in FIG. 5 are shown at the corresponding point of the system of FIG. 2. It is noted again that each of the load balancers 204, 208, 212, 214 of FIG. 2 may be a load balancer 300.

A request is transmitted 500 from the UE 202. The request is received 502 by the external receiver 305 of the first active load balancer 204. The traffic context 316 determines 504 whether the request has been received from the client side 216 or the server side 218 and the direction of the request.

As, in this case, the request was received from the client side, the traffic scheduler 314 determines one or more of the traffic servers 206a-c to which the data packet should be transmitted based on the source network address for the request. The load balancer 300 may optionally also determine whether defragmentation/fragmentation is required based, for example, on the port number in the header of the data packet, and may base the traffic server 206a-c determination on unique IDs associated with each traffic server 206a-c, as described above.

The internal transmitter 302 transmits 508 the data packet to the determined traffic server 206a-c. In the example shown in FIGS. 2 and 5, the request is received from the client side 216 and is entering the system 200.

The determined traffic server 206b receives and processes 510 the request and transmits 512 the request to the second active load balancer 208.

The internal receiver 304 of the second active load balancer 208 receives the request and the external transmitter 303 transmits it 514 to the origin server 210. Optionally, the traffic scheduler 314 of the second load balancer 208 may determine whether defragmentation/fragmentation is required. The origin server 210 responds 516 with the requested data, which is received 518 by the external receiver 305 of the second active load balancer 208.

The traffic context 316 of the second active load balancer 208 determines 520 the traffic domain and direction of the response data. The traffic scheduler 316 of the second active load balancer 208 determines 522 the traffic server 206b based on the destination network address of the data packet, as described above. The second load balancer 208 may optionally also determine whether defragmentation/fragmentation is required based, for example, on the port number in the data packet header.

The internal transmitter 302 of the second active load balancer 208 transmits 524 the data to the determined traffic server 206b, which processes 526 the data and transmits it 528 to the first active load balancer 204. The data is received by the internal receiver 304 of the first active load balancer 204 and the external transmitter 303 transmits 530 the data to the UE 102.

In the above method, both of the forward routing and reverse routing create no session and/or connection data. Further, as the standby load balancers 212, 214 are configured in the same way as the active load balancers 204, 208, there is no requirement to synchronise between them. That is, the session and connection data is not required to ensure the same traffic server 206a-c is used for forward and reverse routing by the active and standby load balancers because the active and standby load balancers are configured to determine traffic servers in the same way. Therefore, there is no need to synchronise that data between active and standby load balancers.

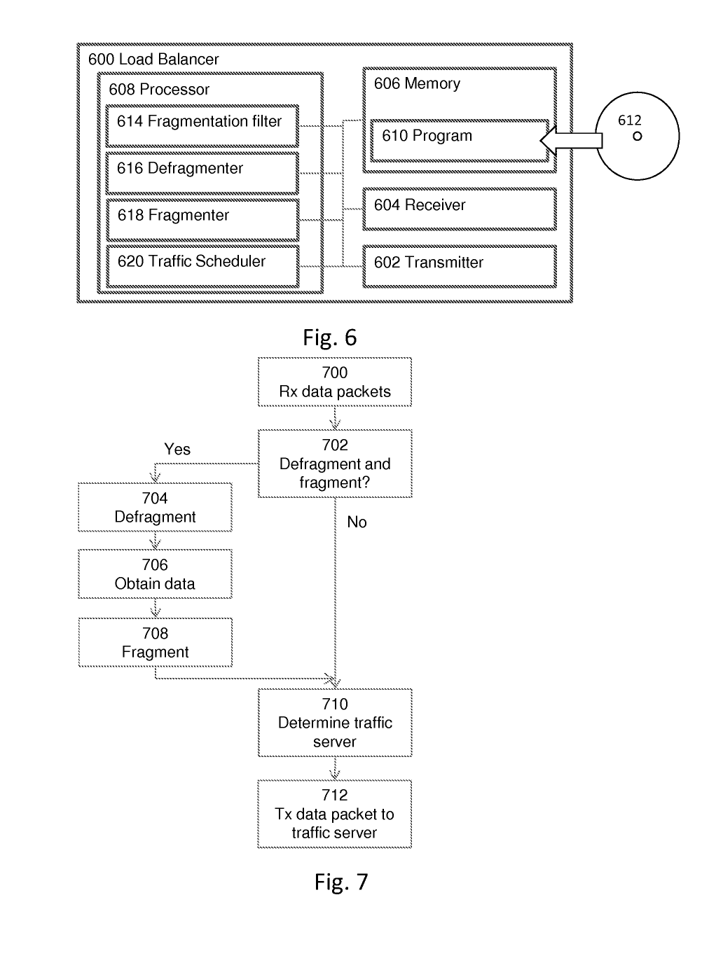

FIG. 6 shows an exemplary load balancer 600. In exemplary systems 200, one or more of the first and second active and standby load balancers 204, 208, 212, 214 may be a load balancer 600. The load balancer 600 may comprise one or more features of the load balancer 300 that are not shown in FIG. 6.

The load balancer 600 comprises a transmitter 602 and a receiver 604. The transmitter 602 and receiver 604 may be configured to undertake the functions of the internal and external transmitters and internal and external receivers described above in respect of load balancer 300. Alternatively, the load balancer 600 may comprise internal and external transmitters and internal and external receivers, as shown in FIG. 3. The transmitter 602 and receiver 604 are in electrical communication with other nodes, UEs, traffic servers and/or functions in a computer network and are configured to transmit and receive data accordingly.

The load balancer 600 further comprises a memory 606 and a processor 608. The memory 606 may comprise a non-volatile memory and/or a volatile memory. The memory 606 may have a computer program 610 stored therein. The computer program 610 may be configured to undertake the methods disclosed herein. The computer program 610 may be loaded in the memory 606 from a non-transitory computer readable medium 612, on which the computer program is stored. The processor 608 is configured to undertake the functions of a fragmentation filter 614, a defragmenter 616, a fragmenter 618 and a traffic scheduler 620.

Each of the transmitter 602, receiver 604, memory 606, processor 608, fragmentation filter 614, defragmenter 616, fragmenter 618 and traffic scheduler 620 is in electrical communication with the other features 602, 604, 606, 608, 610, 614, 616, 618, 620 of the load balancer 600. The load balancer 600 can be implemented as a combination of computer hardware and software. In particular, fragmentation filter 614, defragmenter 616, fragmenter 618 and traffic scheduler 620 may be implemented as software configured to run on the processor 608. The memory 606 stores the various programs/executable files that are implemented by a processor 608, and also provide a storage unit for any required data. The programs/executable files stored in the memory 606, and implemented by the processor 608, can include the fragmentation filter 614, defragmenter 616, fragmenter 618 and traffic scheduler 620, but are not limited to such.

The function of the fragmentation filter 614, defragmenter 616, fragmenter 618 and traffic scheduler 620 is similar to that described above in relation to the load balancer 300 and is not explained again here.

Referring to FIG. 7, a flow diagram is described for a method for distributing network traffic between one or more of a plurality of traffic servers 206a-c.

A plurality of data packets is received 700 at the receiver 604. The fragmentation filter 614 determines 702 whether the received data packets comprise a plurality of fragmented data packets that require defragmentation and subsequent fragmentation, as set out above.

If defragmentation and fragmentation are required, the defragmenter 616 defragments 704 the plurality of fragmented data packets. The load balancer 600 is then able to obtain the requisite data from the defragmented data packets. The fragmenter 618 fragments 708 the defragmented data packets ready for transmission to a traffic server 206a-c. If no defragmentation and fragmentation is required, the method proceeds directly to determining 710 the traffic server 206a-c to which the data packets are to be transmitted and the transmitter 602 transmits 712 the data packets to the determined traffic server 206a-c.

By only undertaking defragmentation and fragmentation on specific data packets for which it is required, the computational burden on the load balancer 600 is reduced. In addition, the latency of the load balancer is improved, as data packets may pass through the load balancer 600 more quickly.

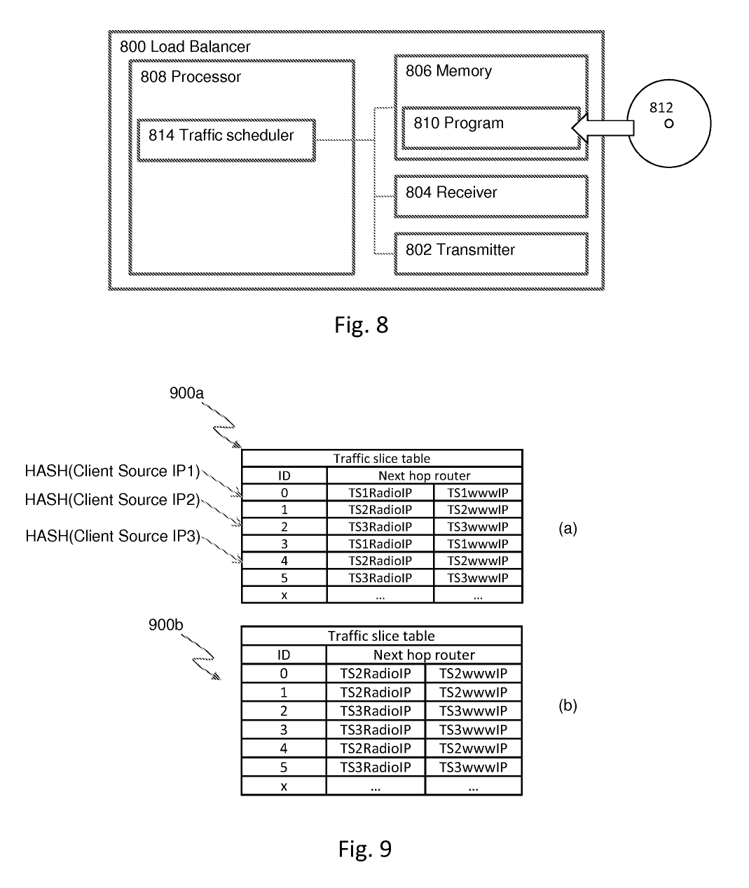

FIG. 8 shows an exemplary load balancer 800. In exemplary systems 200, one or more of the first and second active and standby load balancers 204, 208, 212, 214 may be a load balancer 600. The load balancer 600 may comprise one or more features of the load balancer 300 that are not shown in FIG. 6.

The load balancer 800 comprises a transmitter 802 and a receiver 804. The transmitter 602 and receiver 604 may be configured to undertake the functions of the internal and external transmitters and internal and external receivers described above in respect of load balancer 300. Alternatively, the load balancer 600 may comprise internal and external transmitters and internal and external receivers, as shown in FIG. 3. The transmitter 802 and receiver 804 are in electrical communication with other nodes, UEs, traffic servers and/or functions in a computer network and are configured to transmit and receive data accordingly.

The load balancer 800 further comprises a memory 806 and a processor 808. The memory 806 may comprise a non-volatile memory and/or a volatile memory. The memory 806 may have a computer program 810 stored therein. The computer program 810 may be configured to undertake the methods disclosed herein. The computer program 810 may be loaded in the memory 806 from a non-transitory computer readable medium 812, on which the computer program is stored. The processor 808 is configured to undertake the functions of a traffic scheduler 814.

Each of the transmitter 802, receiver 804, memory 806, processor 808 and traffic scheduler 814 is in electrical communication with the other features 802, 804, 806, 808, 810, 814 of the load balancer 800. The load balancer 800 can be implemented as a combination of computer hardware and software. In particular, traffic scheduler 814 may be implemented as software configured to run on the processor 808. The memory 806 stores the various programs/executable files that are implemented by a processor 808, and also provide a storage unit for any required data. The programs/executable files stored in the memory 806, and implemented by the processor 808, can include the traffic scheduler 814, but are not limited to such.

The traffic scheduler 814 is configured to associate each of a plurality of traffic servers 206a-c with a unique ID. The association is stored in the memory 806 and, in exemplary load balancers 800, may be stored in a slice table. In exemplary systems, both the request traffic (forward routing) and the response traffic (reverse routing) share the same slice tables. The same scheduler 814 and same slice table allow a forward and reverse routing session to be handled by one traffic server.

FIGS. 9a and 9b show exemplary slice tables 900a, 900b stored in memory 806. Referring firstly to FIG. 9a, each traffic server 206a-c is represented as one of N slices in the slice table 900a. This is shown in the table 900a by each traffic server having at least one separate row of the table and having associated with it, a unique ID. The unique ID may be a hash of the source network address or destination network address for a data packet. It is noted that the term “unique ID” may refer to an ID identifying only one traffic server, that is, an identifier that identifies a unique traffic server. A unique ID may identify only one traffic server, but a traffic server may be identified by a plurality of unique IDs.

The table 900b shows the scenario where traffic servers with unique IDs 0 and 3 are down or a service on those servers is crashed. In this case, the slices in the table 900b for those traffic servers are replaced by the slices of other available traffic servers. The unique IDs of the remaining traffic servers remain unaffected. Therefore, new incoming data packets are distributed to the remaining available traffic servers. The data packets may be distributed evenly to remaining available traffic servers. When those traffic servers are up (or back online), the slices of the table 900b for the traffic servers re-take the slices of other available traffic servers. New incoming data packets are directed to the traffic servers with unique IDs 0 and 3 once again. The rescheduling does not impact the online session in any existing available traffic server, which may be a significant advantage of exemplary apparatus disclosed herein.

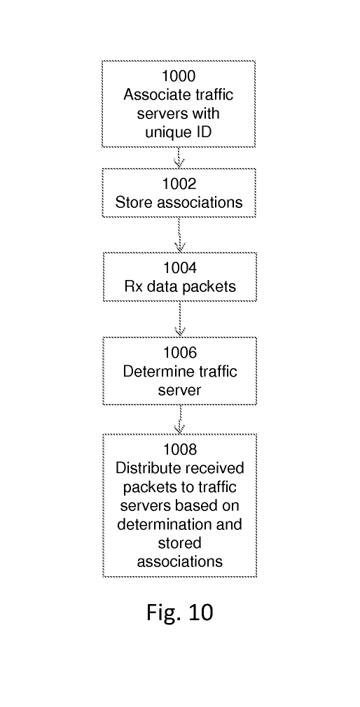

FIG. 10 is a flow diagram showing a method for distributing network traffic between one or more of a plurality of traffic servers 206a-c. The traffic scheduler 814 associates 1000 each of a plurality of traffic servers 206a-c with a unique ID and stores 1002 the associations in the memory 806. Data packets are received 1004 at a receiver 804 of the load balancer 800. A traffic scheduler 814 determines 1006 a traffic server 206a-c to which the received data packets are to be transmitted for load balancing purposes. The transmitter 802 transmits 1008 the data packet to a traffic server based on the determination and the stored associations. If a traffic server 206a-c goes down or is unable to provide a particular service, the unique identifiers for the remaining traffic servers are unaffected. Therefore, in these cases the traffic scheduler 814 distributes newly received data packets to one or more of the remaining traffic servers 206a-c.

A computer program may be configured to provide any of the above described methods. The computer program may be provided on a computer readable medium. The computer program may be a computer program product. The product may comprise a non-transitory computer usable storage medium. The computer program product may have computer-readable program code embodied in the medium configured to perform the method. The computer program product may be configured to cause at least one processor to perform some or all of the method.

Various methods and apparatus are described herein with reference to block diagrams or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

Computer program instructions may also be stored in a computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/Blu-ray).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks.

Accordingly, the invention may be embodied in hardware and/or in software (including firmware, resident software, micro-code, etc.) that runs on a processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated.

The skilled person will be able to envisage other embodiments without departing from the scope of the appended claims.

1. A load balancer for use in a computer network and for distributing network traffic between one or more of a plurality of traffic servers, the load balancer comprising:
an external receiver configured to receive data packets from one or more of a client side and a server side;
a traffic scheduler configured to determine a traffic server to which a received data packet is to be transmitted; and
an internal transmitter configured to transmit the data packet to the determined traffic server,
wherein, if the data packet is received from the client side, the traffic scheduler is configured to determine the traffic server based on a source network address for the data packet,
and wherein, if the data packet is received from the server side, the traffic scheduler is configured to determine the traffic server based a destination network address for the data packet.

2. The load balancer of claim 1, wherein the traffic scheduler is configured to determine the traffic server using a hash of the source or destination network address.

3. The load balancer of claim 1, further comprising a traffic context configured to determine the traffic domain and the direction of the data packet.

4. The load balancer of claim 1, wherein the external receiver is configured to receive requests comprising received data packets from a user equipment on the client side and/or to receive responses comprising received data packets, from an origin server on the server side, wherein, for a given user equipment, the same traffic server is determined for the requests and responses.

5. The load balancer of claim 1, further comprising a fragmentation filter configured to determine whether the received data packets comprise fragmented data requiring defragmentation and fragmentation before transmission to a traffic server, wherein, if the fragmentation filter determines that the data packets require defragmentation and fragmentation, a defragmenter is configured to defragment the data packets and a fragmenter is configured to fragment the defragmented data packets.

6. The load balancer of claim 5, wherein the fragmentation filter is configured to determine whether the received data packets require defragmentation and fragmentation based on whether the received data packets must be defragmented to determine header information relating to a plurality of fragmented data packets.

7. The load balancer of claim 5, wherein the fragmentation filter is configured to determine whether the received data packets require defragmentation and fragmentation based on a source network address for the data packets received from the client side.

8. The load balancer of claim 5, wherein the fragmentation filter is configured to determine whether the received data packets require defragmentation and fragmentation based on a destination address for the data packets received from the server side.

9. The load balancer of claim 5, wherein the fragmentation filter is configured to determine that the received data packets require defragmentation and fragmentation if the data packets require round-robin scheduling.

10. The load balancer of claim 1, wherein the traffic scheduler is further configured to associate each of the plurality of traffic servers with at least one identifier, and to store the associations in a memory.

11. The load balancer of claim 10 wherein, if one or more of the plurality of traffic servers is unavailable, the traffic scheduler is configured to distribute data packets to one or more remaining traffic servers based on the stored associations between the traffic servers and the at least one identifier without affecting the identifier associated with each traffic server.

12. The load balancer of claim 10, wherein the traffic scheduler is configured to store the associations between the traffic servers and the at least one identifier in the memory using a slice table.

13. The load balancer of claim 11, wherein the traffic scheduler is configured to distribute data packets evenly between remaining available traffic servers.

14. A network node comprising the load balancer of claim 1.

15. A method for distributing network traffic between one or more of a plurality of traffic servers, the method comprising:
receiving, by an external receiver, a data packet from a client side and/or a server side;
determining, by a traffic scheduler, a traffic server to which the received data packet is to be transmitted; and
transmitting by an internal transmitter, the data packet to the determined traffic server,
wherein, if the data packet is received from the client side, the traffic server is determined based on a source network address for the data packet,
and wherein, if the data packet is received from the server side, the traffic server is determined based on a destination network address for the data packet.

16. The method of claim 15, wherein determining the traffic server using a hash of the source or destination network address.

17. The method of claim 15, further comprising determining, by a traffic context, the traffic domain and the direction of the data packet.

18. The method of claim 15, wherein receiving a data packet comprises receiving requests from a user equipment on the client side and/or receiving responses from an origin server on the server side, wherein, for a given user equipment, the same traffic server is determined for the requests and responses.

19. The method of claim 15, further comprising determining, by a fragmentation filter, whether the received data packets comprise fragmented data requiring defragmentation and fragmentation before transmission to a traffic server, wherein, if the fragmentation filter determines that the data packets require defragmentation and fragmentation, the method further comprises defragmenting, by a defragmenter, the data packets and fragmenting, by a fragmenter, the defragmented data packets.

20. The method of claim 19, wherein determining whether the received data packets require defragmentation and fragmentation is based on whether the received data packets must be defragmented to determine header information relating to a plurality of fragmented data packets.

21. The method of claim 19, wherein determining whether the received data packets require defragmentation and fragmentation is based on a source network address for the data packets received from the client side.

22. The method of claim 19, wherein determining whether the received data packets require defragmentation and fragmentation is based on a destination address for the data packets received from the server side.

23. The method of claim 19, wherein determining that the received data packets require defragmentation and fragmentation is based on whether the data packets require round-robin scheduling.

24. The method of claim 15 further comprising associating, by the traffic scheduler, each of the plurality of traffic servers with at least one identifier, and to storing, by the traffic scheduler, the associations in a memory.

25. The method of claim 24, wherein, if one or more of the plurality of traffic servers is unavailable, the traffic scheduler distributes data packets to one or more remaining traffic servers based on the stored associations between the traffic servers and the at least one identifier without affecting the identifier associated with each traffic server.

26. The method of claim 24, wherein the traffic scheduler stores the associations between the traffic servers and the at least one identifier in the memory using a slice table.

27. The method of claim 25, wherein the traffic scheduler distributes data packets evenly between remaining available traffic servers.

28. A non-transitory computer readable medium comprising computer readable code configured, when read by a computer, to carry out the method of claim 15.

29. (canceled)

30. A system for use in a computer network and for distributing network traffic between one or more of a plurality of traffic servers, the system comprising:
first and second load balancers and a plurality of traffic servers,
wherein the first load balancer comprises a first external receiver configured to receive a first data packet from a client side node, a first traffic scheduler configured to determine a first traffic server from the plurality of traffic servers based on a source network address for the first data packet, and a first internal transmitter configured to transmit the first data packet to a second internal receiver 304 of the second load balancer via the determined first traffic server, a second external transmitter of the second load balancer being configured to transmit the first data packet to a server side node,
and wherein the second load balancer comprises a second external receiver configured to receive a second data packet from the server side node, a second traffic scheduler configured to determine a second traffic server from the plurality of traffic servers based on a destination network address for the second data packet, a second internal transmitter configured to transmit the second data packet to a first internal receiver of the first load balancer via the determined second traffic server, a first external transmitter of the first load balancer being configured to transmit the second data packet to the client side node,
wherein the first determined traffic server is the same as the second determined traffic server.

31. A method for operating a system for use in a computer network and for distributing network traffic between one or more of a plurality of traffic servers, the method comprising:
at a first active load balancer:
receiving, by a first external receiver a first data packet from a client side node;
determining, by a first traffic scheduler, a first traffic server from the plurality of traffic servers based on a source network address for the first data packet; and
transmitting, by a first internal transmitter, the first data packet to a second load balancer via the determined first traffic server,
at a second load balancer;
receiving, at a second internal receiver, the first data packet;
transmitting, by a second external transmitter, the first data packet to a server side node;
receiving, by a second external receiver, a second data packet from the server side node;
determining, by a second traffic scheduler, a second traffic server from the plurality of traffic servers based on a destination network address for the second data packet; and
transmitting, by a second internal transmitter, the second data packet to the first or a further load balancer via the determined second traffic server; and
at the first or further load balancer:
transmitting, by a first external transmitter, the second data packet to the client side node,
wherein the first determined traffic server is the same as the second determined traffic server.

32. A load balancer for use in a computer network and for distributing network traffic between one or more of a plurality of traffic servers, the load balancer comprising:
a receiver configured to receive a plurality of data packets from a client side and/or a server side;
a traffic scheduler configured to determine one or more traffic servers to which the data packets are to be transmitted; and
a transmitter configured to transmit the data packets to the one or more determined traffic servers,
wherein the traffic scheduler is further configured to associate each of the plurality of traffic servers with a unique identifier, and to store the associations in a memory,
and wherein, if one or more of the plurality of traffic servers is unavailable, the traffic scheduler is configured to distribute data packets to one or more remaining traffic servers based on the stored associations between the traffic servers and the at least one identifier without affecting the identifier associated with each traffic server.

33. The load method of claim 32, wherein the traffic scheduler is configured to store the associations between the traffic servers and the at least one identifier in the memory using a slice table.

34. The load balancer of claim 33, wherein the traffic scheduler is configured, if one or more of the plurality of traffic servers is unavailable, to determine one or more second traffic servers to which the data packets are to be transmitted based on the slice table.

35. A method for distributing network traffic between one or more of a plurality of traffic servers, the method comprising:
associating by a traffic scheduler, each of the plurality of traffic servers with a unique identifier;
storing the associations in a memory;
receiving, by a receiver, a plurality of data packets from a client side and/or a server side;
determining, by a traffic scheduler, one or more traffic servers to which the data packets are to be transmitted; and
if one or more of the plurality of traffic servers is unavailable, distributing, by the traffic scheduler, the data packets to one or more remaining traffic servers based on the stored associations between the traffic servers and the at least one identifier without affecting the identifier associated with each traffic server.

36. A non-transitory computer readable medium comprising computer readable code configured, when read by a computer, to carry out the method of claim 35.

37. (canceled)
